(19) United States
(12) Patent Application Publication
(10) Pub. No.: US 2011/0017806 A1
(43) Pub. Date: Jan. 27, 2011

(54) FORMING GAS KIT DESIGN FOR COPPER BONDING

(76) Inventors: Jerry Gomez Cayabyab, Baguio City (PH); Timer D. Porras, Baguio City (PH); Allan I. Dacanay, La Union (PH)

Correspondence Address: TEXAS INSTRUMENTS INCORPORATED, P O BOX 655474, M/S 3999, DALLAS, TX, 75265, US

(21) Appl. No.: 12/506,690

(22) Filed: Jul. 21, 2009

(51) Int. Cl. B23K 20/10; B23K 31/02; B23K 3/08

(52) U.S. Cl. 228/110.1; 228/219; 228/42

(57) ABSTRACT

A wire bond apparatus and method can include wire bonder head having a capillary there through and a bond wire within the capillary. A forming gas inlet to the capillary allows injection of forming gas directly into the wire bond head capillary. The forming gas can be forced from the end of the capillary to accurately envelop an end of the bond wire in forming gas during free-air ball formation, which can decrease oxidation of the free-air ball during formation, reduce a quantity of forming gas used, and result in a more symmetrical free-air ball and an improved bond wire attachment.

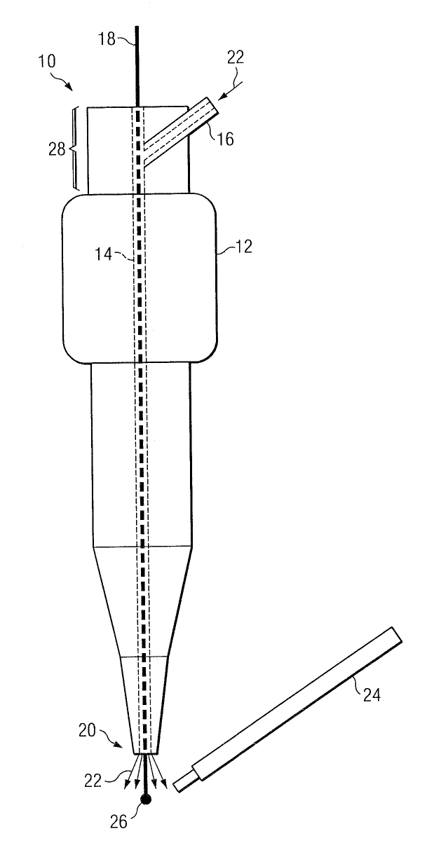

### FIELD OF THE INVENTION

This invention relates to the manufacture of semiconductor devices, and more particularly to a wire bonding apparatus for use with copper or other bonding.

### BACKGROUND OF THE INVENTION

During the formation of a semiconductor device, bond pads (i.e. interconnect terminals) on a semiconductor die can be electrically connected to leadframe leads, pads on a substrate, or to bond pads on another die using a wire bond apparatus (wire bonder) to form wire bonds. To form a wire bond, a bond wire is passed through a capillary in a wire bond head and out an opening at the end of the capillary. The end of the bond wire is exposed to a spark (flame, flare, arc, heated coil, etc.) from an electronic flame off (EFO) wand, which heats and melts the end of the wire to create a ball, referred to as a “free-air ball” (FAB), on the end of the bond wire.

During the heating of the bond wire by the spark from the EFO, metal which forms the bond wire can oxidize, particularly in a wire bonding process using a copper wire. Oxidation of the bond wire can result in problems such as a higher-resistance and/or less secure connection subsequent to the bonding process. To minimize oxidation, the end of the bond wire can be exposed to an inert gas, referred to as a “forming gas.” The forming gas can be supplied by gas supplied through a separate forming gas tube having an outlet near the end of the bond wire, or through a gas tube through the EFO wand.

### SUMMARY OF THE EMBODIMENTS

In contemplating conventional wire bonders having a forming gas supply, either through a separate forming gas tube or through a gas tube in the electronic flame-off (EFO) wand, the inventors have realized various deficiencies in conventional design.

In various conventional forming gas supplies, the gas exits through an opening which is laterally located from the end of the bond wire where the free-air ball (FAB) is formed. Interactions between the force of the gas expelled from the supply and the bond wire can result in the opposite side of the bond wire being exposed to ambient air rather than the inert gas, resulting in partial oxidation of the bond wire and FAB subsequent to its formation. Additionally, the force of the forming gas on the FAB during formation can result in a FAB which is not symmetrical.

In realizing the shortcomings of current practice, the inventors have developed a wire bond head which can supply an inert forming gas to an end of the bond wire in a uniform manner. In an embodiment, a wire bond head includes a forming gas inlet which supplies the forming gas to the bond head tube (capillary) which also supplies the bond wire. The forming gas can exit the end of the capillary along with the bond wire to provide a more uniform gas supply to the end of the bond wire during FAB formation. Additionally, lateral forming gas pressure which can form a misshapen FAB is avoided, as the forming gas is supplied from a direction parallel with the wire bond.

### BRIEF DESCRIPTION OF THE DRAWINGS

The accompanying drawing, which is incorporated in and constitutes a part of this specification, illustrates an embodiment of the invention and together with the description, serves to explain the principles of the invention.

The single FIG. is a cross section depicting a wire bond head, bond wire, and electronic flame-off wand in accordance with an embodiment of the invention.

It should be noted that some details of the FIG. may have been simplified and drawn to facilitate understanding of the inventive embodiments rather than to maintain strict structural accuracy, detail, and scale.

### DESCRIPTION OF THE EMBODIMENTS

Reference will now be made in detail to the present embodiment (exemplary embodiment) of the invention, an example of which is illustrated in the accompanying drawing. Wherever possible, the same reference numbers will be used to refer to the same or like parts.

To supply an inert forming gas to an end of a bond wire, a wire bonder head similar to that depicted in the single FIG. cross section can be provided. The FIG. depicts a wire bond head 10 which can include a transducer 12, a capillary 14 adapted to have a bond wire therein during wire bond formation, and an inert forming gas inlet 16.

In use, a bond wire 18 is provided within the capillary 14 of the wire bond head 10. The bond wire 18 extends through the capillary 14 and out through a capillary opening at an end 20 of the wire bond head 10. A conductive bond wire 18 can be formed from a metal such as gold, copper, aluminum, an alloy, etc. An amount of forming gas 22 is in injected into the forming gas inlet 16, for example from a supply tube (not depicted) and flows through the capillary 14, where it is forced through the capillary and ejected from the end 20 of the wire bond head 10. The gas 22 envelops the portion of the bond wire 18 extending from the end 20 of the wire bond head 10. A heat source such as an electronic flame-off (EFO) head 24 can create a spark to heat the end of the bond wire 18 to create a free air ball (FAB) 26 on the end of the bond wire.

Subsequent to forming the FAB 26, the transducer 12 can create an ultrasonic vibration to electrically and mechanically attach the FAB 26 to a conductive surface such as a semiconductor die bond pad, a substrate pad such as a printed circuit board landing pad, etc. in accordance with known techniques.

A conventional wire bond head, for example a wire bond head to form a gold wire bond, can be modified to include a forming gas inlet. Access to the bond wire capillary can be gained, for example, through a subassembly 28 which can extend from the transducer 12 or from another capillary access point.

In accordance with an embodiment of the invention, the capillary 14 can have a sufficient diameter such that an adequate supply of forming gas 22 can be injected into the forming gas inlet 16 and out the end 20 of the bond head without excessive pressure. For a bond wire between about 15 micrometers (μm) and about 60 μm in diameter, a capillary between about 19 μm and about 65 μm would be sufficient. In this particular use, a forming gas including between about 90% and about 98% nitrogen (N₂) and between about 2% and about 10% hydrogen would be sufficient. A forming gas flow rate of between about 200 standard cubic centimeters (sccm) and about 1,000 sccm at a pressure of between about 15 pounds/in² (PSI) and about 70 PSI should provide sufficient forming gas 22 to the end of the bond wire 18 extending from the end 20 of the bond head 10 without excessive pressure to the FAB 26 during its formation.

In contrast to some conventional devices which provide forming gas to the bond wire from a lateral direction, either through a separate forming gas tube or through a tube from the EFO, the forming gas of the described embodiment is provided with a generally equal, even, and balanced pressure to the end of the bond wire and to the FAB during formation. This can result in a more symmetrical FAB which has decreased incidence of oxidation, and thereby can result in an improved wire bond attachment.

In addition, an embodiment can decrease forming gas use, and therefore decrease costs, because the forming gas is more accurately directed to the desired location, specifically to the end of the bond wire where FAB formation occurs. In contrast to prior devices and methods where a gas outlet can be more than about 150 mils away from the end of the bond wire, a distance from the end of the wire bond head and the end of the bond wire where FAB formation will occur can be less than 100 μm and more particularly less than about 80 μm, for example between about 50 μm and about 80 μm. Further, conventional processes may require multiple gas sources to adequately envelop the end of the wire bond during FAB formation, which further increases forming gas use. Thus the gas flow rate described above is less than is possible with other conventional devices while providing a flow which sufficiently minimizes oxidation of the bond wire during FAB formation.

Additionally, an embodiment of the invention can provide for a copper wire bonder having improved capillary change accessibility over a conventional copper bonder. Providing a forming gas through the capillary of the wire bonder head itself, for example through the use of a subassembly 28 as depicted in the single FIG., requires minimal design changes over a gold wire bonder. Capillary access similar to that of a gold wire bonder can be gained by simply removing a gas supply tube from the forming gas inlet. Conventional copper wire bonders can require a more complex disassembly to access the capillary, as additional structures are required to supply the forming gas which restrict access to the capillary.

Thus an embodiment of the invention can provide a balanced forming gas blow during free-air ball formation to provide a more uniform free-air ball with decreased oxidation. Decreasing oxidation is particularly important with materials which have a higher incidence of oxidation, such as with copper bonding processes. An embodiment can also provide for improved capillary change accessibility, and can simplify copper kit design.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 5. In certain cases, the numerical values as stated for the parameter can take on negative values. In this case, the example value of range stated as “less that 10” can assume negative values, e.g. −1, −2, −3, −10, −20, −30, etc.

While the invention has been illustrated with respect to one or more implementations, alterations and/or modifications can be made to the illustrated examples without departing from the spirit and scope of the appended claims. In addition, while a particular feature of the invention may have been disclosed with respect to only one of several implementations, such feature may be combined with one or more other features of the other implementations as may be desired and advantageous for any given or particular function. Furthermore, to the extent that the terms “including,” “includes,” “having,” “has,” “with,” or variants thereof are used in either the detailed description and the claims, such terms are intended to be inclusive in a manner similar to the term “comprising.” The term “at least one of” is used to mean one or more of the listed items can be selected. Further, in the discussion and claims herein, the term “one used with respect to two materials, one “on” the other, means at least some contact between the materials, while “over” means the materials are in proximity, but possibly with one or more additional intervening materials such that contact is possible but not required. Neither “on” nor “over” implies any directionality as used herein. The term “conformal” describes a coating material in which angles of the underlying material are preserved by the conformal material. The term “about” indicates that the value listed may be somewhat altered, as long as the alteration does not result in nonconformance of the process or structure to the illustrated embodiment. Finally, “exemplary” indicates the description is used as an example, rather than implying that it is an ideal. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A method for forming a wire bond for an electronic device comprising:
providing a wire bond head having a capillary there through and an opening at an end of the capillary;
injecting an amount of forming gas into the capillary of the wire bond head while extending a bond wire through the capillary; and
forming a free-air ball at an end of the bond wire while exposing the end of the bond wire to the forming gas emitted from the opening at the end of the capillary.

2. The method of claim 1, further comprising injecting the amount of forming gas into the capillary through a forming gas inlet which is part of a subassembly attached to a wire bond head transducer.

3. The method of claim 1 further comprising injecting the forming gas through the forming gas inlet at a flow rate of between about 200 sccm and about 1,000 sccm.

4. The method of claim 1 further comprising emitting the forming gas from the opening at the end of the capillary at a distance of between about 50 μm and about 80 μm from the opening at the end of the capillary to the end of the bond wire.

5. The method of claim 1 further comprising extending a copper bond wire through the capillary.

6. A wire bonder apparatus comprising:
a wire bond head having a capillary there through and an opening at an end of the capillary, wherein the capillary is adapted to have a bond wire therein during wire bond formation; and
a forming gas inlet into the capillary of the wire bond head.

7. The wire bonder apparatus of claim 6, further comprising:
a bond wire extending through the capillary and out an end of the wire bond head; and
a forming gas within the capillary and at an end of the bond wire.

8. The wire bonder apparatus of claim 7 wherein a distance from the end of the wire bond head to the end of the bond wire is between about 50 μm and about 80 μm.

9. The wire bonder apparatus of claim 7, further comprising a free-air ball at the end of the bond wire.
